(19) United States
(12) Patent Application Publication
(10) Pub. No.: US 2020/0362606 A1
(43) Pub. Date: Nov. 19, 2020

(54) Locking Slider for Door Trim

(71) Applicants: Hyundai Motor Company, Seoul (KR); Kia Motors Corporation, Seoul (KR)

(72) Inventor: Je-Won Choi, Anyang-si (KR)

(21) Appl. No.: 16/684,680

(22) Filed: Nov. 15, 2019

(30) Foreign Application Priority Data
May 14, 2019 (KR) 10-2019-0056475

(51) Int. Cl. E05B 83/40; E05B 83/38; B60J 5/08

(52) U.S. Cl. CPC E05B 83/40; B60J 5/08; E05B 83/38

(57) ABSTRACT

A locking slider can be used for a door trim, which has a plate and is mounted on a center roller of a sliding door. The locking slider includes two opening/closing members that are positioned on the plate to face each other and fastened or unfastened as multiple protrusions thereof engage or disengage. Two coupling members are formed at both sides of the plate to face each other so as to allow the opening/closing members to be seated on a movement route of the sliding door. The coupling members are configured to apply force to the opening/closing members from outside to inside. A separating member is formed at one side of the plate so as to be positioned between the coupling members. The separating member is configured to apply force to the opening/closing members from inside to outside.

### CROSS-REFERENCE TO RELATED APPLICATIONS

This application claims priority to Korean Patent Application No. 10-2019-0056475, filed in the Korean Intellectual Property Office on May 14, 2019, which application is hereby incorporated herein by reference.

### TECHNICAL FIELD

The present invention relates to a locking slider for a door trim.

### BACKGROUND

In general, a vehicle has an occupant compartment having a predetermined size in which a driver or an accompanied occupant may be seated, and opening/closing doors are installed on a vehicle body to open or close the occupant compartment.

In particular, a slide-type occupant compartment opening/closing door is configured to move rearward in a longitudinal direction of a vehicle to open an occupant compartment and move forward in the longitudinal direction of the vehicle to close the occupant compartment. Therefore, the slide-type occupant compartment opening/closing door has an advantage in that a space required to open or close the door is small in comparison with a hinge-type occupant compartment opening/closing door.

In the case of opposite sliding doors, which include a front door and a rear door that face each other, among types of sliding doors, an upper rail, a center rail, and a lower rail are required to mount the doors on a vehicle body in the related art. However, there is a limitation in designing a curved roof for a vehicle if a rectilinear upper rail is used, and there is a limitation in designing a fender and a head lamp connecting portion if a rectilinear center rail is used.

To solve the problems, Korean Patent No. 10-1637289 discloses that only a center rail mounted on a front door and/or a rear door and a lower rail mounted on a vehicle body are used, such that the number of components, a weight, and costs of a vehicle may be reduced, and a degree of design freedom of an external appearance of the vehicle may be improved.

However, referring to a configuration in the related art with reference to FIGS. 1 and 2, a center roller 20 mounted on a vehicle body needs to be operated along a center rail 30 mounted on a sliding door 10 to open the sliding door 10, and as a result, an opening portion 40. needs to be provided in a door trim at the periphery of the center rail 30 for providing an operating space.

Specifically, as illustrated in FIG. 2, an upper side of the center rail 30 and an upper side of the center roller 20 may be covered by an upper trim 50, but a lower side of the center rail 30 and a lower side of the center roller 20 are opened through the opening portion 40. Since the opening portion 40 is exposed, there is a limitation in optimizing NVH (noise, vibration and harshness) characteristics because of wind noise, road noise, or the like generated while the vehicle travels. In addition, foreign substances may be introduced into the vehicle when the vehicle travels in a harsh environment such as a rainy environment or an environment with high dust concentration, and a part of a human body is inserted into the opening portion 40, which may cause the human body to get dirty or a problem with safety.

### SUMMARY

The present invention relates to a locking slider for a door trim. Particular embodiments relate to a locking slider capable of locking or unlocking an opening portion formed in a lower portion of a door trim when a sliding door moves.

Embodiments of the present invention can provide a new structure having a simple configuration capable of locking or unlocking an opening portion formed in a lower portion of a door trim.

An exemplary embodiment of the present invention provides a locking slider for a door trim which has a plate and is mounted on a center roller of a sliding door. The locking slider for a door trim according to exemplary embodiment of the present invention includes two opening/closing members which are positioned on the plate to face each other and fastened or unfastened as multiple protrusions thereof engage or disengage. Two coupling members are formed at both sides of the plate to face each other so as to allow the opening/closing members to be seated on a movement route of the sliding door, and configured to apply force to the opening/closing members from outside to inside. A separating member is formed at one side of the plate so as to be positioned between the coupling members, and configured to apply force to the opening/closing members from inside to outside.

According to the present invention, the opening portion formed in the lower portion of the door trim may be blocked as the opening/closing members are locked when the sliding door is closed, and as a result, it is possible to prevent substances produced outside the vehicle or noise generated when the vehicle travels from being introduced into the vehicle.

According to the present invention, with the rollers formed on the coupling member and the separating member, the rotation of the coupling member, and the circular shape of the protrusion, it is possible to reduce friction, noise, or the like that may be generated when the protrusions formed on the opening/closing members come into contact with one another.

### BRIEF DESCRIPTION OF THE DRAWINGS

FIG. 1 is a view illustrating a trim opening portion formed in a lower portion of a center rail in the related art.

FIG. 2 is a cross-sectional view taken along line A-A′ in FIG. 1.

FIG. 3 is a view illustrating a state in which a locking slider according to an exemplary embodiment of the present invention is mounted on a center roller.

FIG. 4 is a perspective view illustrating the locking slider according to the exemplary embodiment of the present invention.

FIG. 5 is a view illustrating a state in which coupling members of the locking slider illustrated in FIG. 4 rotate.

FIG. 6 is a view illustrating opening/closing members according to the exemplary embodiment of the present invention.

FIG. 7 is a view illustrating opening/closing members according to another exemplary embodiment of the present invention.

FIG. 8 is a view illustrating an operating state of the locking slider while a door is closed.

FIG. 9 is a view illustrating an operating state of the locking slider while the door is opened.

FIGS. 10A to 10C are views illustrating a process in which an opening portion of a door trim is locked until the door in an opened state is closed.

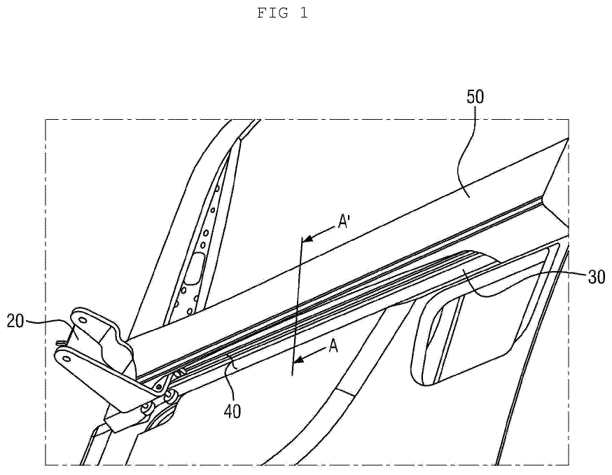

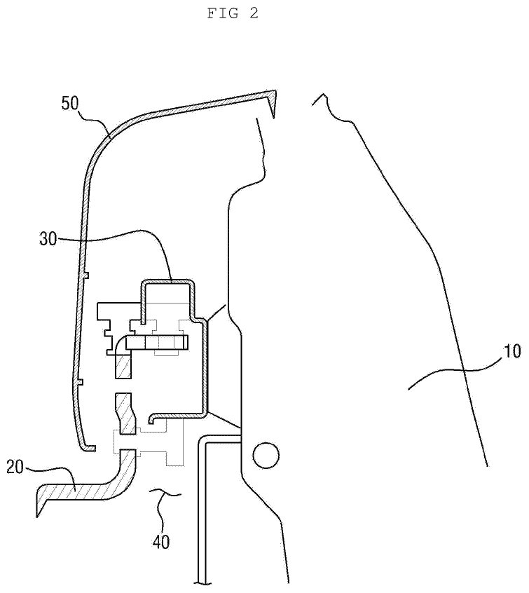

### DETAILED DESCRIPTION OF ILLUSTRATIVE EMBODIMENTS

Hereinafter, exemplary embodiments of a locking slider for a door trim according to the present invention will be described in detail with reference to the drawings. Terms or words used herein should not be interpreted as being limited to a general or dictionary meaning and should be interpreted as a meaning and a concept which conform to the technical spirit of the present invention based on a principle that an inventor can appropriately define a concept of a term in order to describe his/her own invention by the best method.

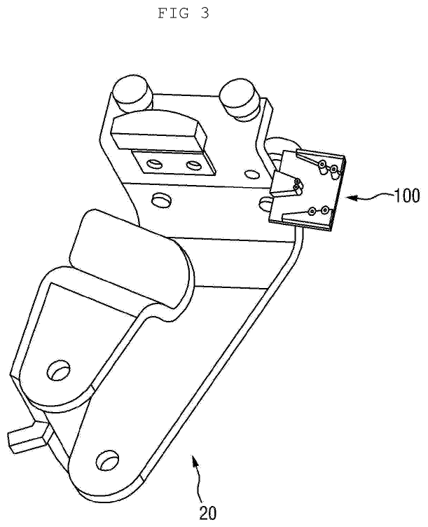

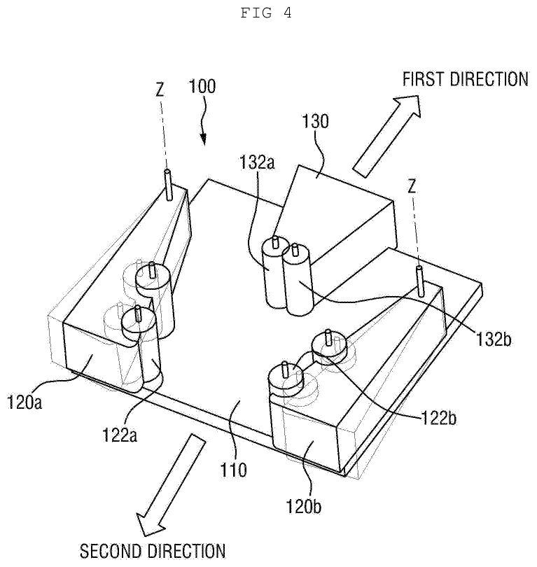

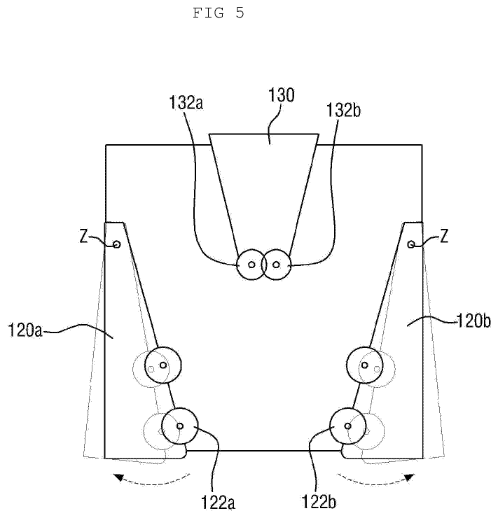

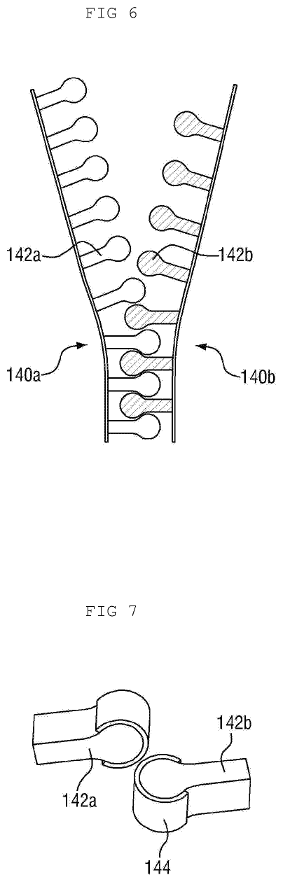

FIG. 3 is a view illustrating a state in which a locking slider for a door trim according to an exemplary embodiment of the present invention is mounted on a center roller, FIG. 4 is a perspective view illustrating the locking slider according to the exemplary embodiment of the present invention, FIG. 5 is a view illustrating a state in which coupling members of the locking slider illustrated in FIG. 4 rotate, FIG. 6 is a view illustrating opening/closing members according to the exemplary embodiment of the present invention, and FIG. 7 is a view illustrating opening/closing members according to another exemplary embodiment of the present invention.

Meanwhile, as described above, a center roller 20 is fixed to a vehicle body, and a center rail 30 is mounted on a sliding door 10. In a state in which the center roller 20 is fixed to the vehicle body, the sliding door 10 may move along the center rail 30 to which the center roller 20 is coupled to be capable of rolling. That is, a movement route through which the sliding door 10 may move may be formed in or in the vicinity of a contact region between the center roller 20 and the center rail 30.

A locking slider 100 for a door trim according to the exemplary embodiment of the present invention is mounted on the center roller 20 and includes a plate 110, coupling members 120a and 120 b, a separating member 130, and opening/closing members 140a and 140b.

The locking slider 100 is mounted at one side of the center roller 20. In a state in which the locking slider 100 is mounted on the center roller 20, the locking slider 100 is parallel to a position at which an opening portion 40 formed in a lower portion of the center rail 30 is covered. As illustrated in FIG. 3, the locking slider 100 is positioned to be perpendicular to a movement surface of the center roller 20. Therefore, when the center roller 20 is mounted on the door 10, the locking slider 100 is positioned in parallel with a lower portion of the opening portion 40. However, in another exemplary embodiment of the present invention, the locking slider 100 may have a different angle with respect to the movement surface of the center roller 20.

The plate 110 according to the exemplary embodiment of the present invention is positioned on the movement route of the sliding door 10 and has a flat shape so that the opening/closing members 140a and 140b to be described below are seated. The shape of the plate 110 is not limited, but the plate 110 may have the flat shape so that the opening/closing members 140a and 140b are stably seated. The coupling members 120a and 120b and the separating member 130 are formed together on one surface of the plate 110.

The coupling members 120a and 120b are formed in parallel with a longitudinal direction of the opening/closing members 140a and 140b, and the two coupling members 120a and 120b are formed at both sides of the plate 110 so as to face each other. Here, the opening/closing members 140a and 140b are seated between the coupling members 120a and 120b, and the movement route of the sliding door 10 is formed between the coupling members 120a and 120b in the longitudinal direction of the opening/closing members 140a and 140b. In this case, the directions of the movement route of the sliding door 10, which is formed in the plate 110, will be described as being divided into a first direction (upward direction in FIG. 4) and a second direction (downward direction in FIG. 4).

The surfaces (hereinafter, referred to as ‘inclined surfaces’) of the two coupling members 120a and 120b, which face each other, have predetermined inclinations so that a distance between the two coupling members 120a and 120b is decreased in the second direction. Therefore, a distance between one end of the coupling member 120b and one end of the coupling member 120b in the first direction is largest, and a distance between the other end of the coupling member 120a and the other end of the coupling member 120b in the second direction is smallest. Here, the distance between the other end of the coupling member 120a and the other end of the coupling member 120b in the second direction may be set such that the two opening/closing members 140a and 140b are coupled to each other.

The coupling members 120a and 120b have coupling rollers 122a and 122b, respectively, that protrude outward from the inclined surfaces. That is, as illustrated in FIGS. 4 and 5, rotation surfaces of the coupling rollers 122a and 122b are exposed outward from the inclined surfaces of the coupling members 120a and 120b, and the coupling roller 122a formed on the coupling member 120a and the coupling roller 122b formed on the coupling member 120b, which faces the coupling member 120a, face each other symmetrically. FIGS. 4 and 5 illustrate the four coupling rollers 122a and 122b positioned to be close to the second direction, but the positions and the number of coupling rollers 122a and 122b are not limited. However, the coupling rollers 122a and 122b may be formed to be close to the second direction so that the opening/closing members 140a and 140b may be coupled to each other.

As illustrated in FIG. 5, one end of the coupling member 120a and one end of the coupling member 120b in the first direction are connected to the plate 110 so as to be rotatable about rotation axes Z. Therefore, the other end of the coupling member 120a and the other end of the coupling member 120b in the second direction may rotate outward from the plate 110 (leftward or rightward based on FIG. 5) about the rotation axes Z of the coupling members 120a and 120b.

The separating member 130 is formed in parallel with the longitudinal direction of the opening/closing members 140a and 140b and formed in the vicinity of a center of the plate no so as to be close to the first direction. Specifically, the separating member 130 is formed on the plate 110 so that the separating member 130 is placed at the center of the opening/closing members 140a and 140b in the state in which the opening/closing members 140a and 140b are seated between the coupling members 120a and 120b.

The separating member 130 according to the exemplary embodiment of the present invention has a predetermined inclination so that an interval in a width direction is decreased in the second direction. Therefore, one end of the separating member 130 is shorter in a length in the width direction than the other end of the separating member 130. Referring to FIGS. 4 and 5, the separating member 130 has a trapezoidal shape. However, in another exemplary embodiment of the present invention, the separating member 130 may have various shapes such as a rectangular shape.

One end surface (an end surface having a short distance in the width direction) of the separating member 130 is positioned to be directed toward the center of the opening/closing members 140a and 140b when the opening/closing members 140a and 140b are seated on the plate 110.

Separating rollers 132a and 132b are provided on the one end surface of the separating member 130 according to the exemplary embodiment of the present invention. As illustrated in FIGS. 4 and 5, the separating rollers 132a and 132b may include a first separating roller 132a and a second separating roller 132b which are formed in parallel on the one end surface of the separating member 130.

Meanwhile, a plate (not illustrated), which is identical to the plate 110, may be placed on a surface of the locking slider 100 on which the coupling members 120a and 120b and the separating member 130 are exposed.

As illustrated in FIG. 6, the two opening/closing members 140a and 140b are formed to face each other, and the opening/closing members 140a and 140b have multiple protrusions 142a and 142b, respectively. The protrusions 142a and 142b may be made of steel or plastic.

The protrusions 142a formed on the opening/closing member 140a are inserted between the protrusions 142b formed the opening/closing member 140b. To reduce friction generated when the protrusions are inserted, one end of each of the protrusions 142a and 142b according to the exemplary embodiment of the present invention has a circular shape having a predetermined curvature.

Referring to FIG. 7, each of the protrusions 142a and 142b according to another exemplary embodiment of the present invention further includes an anti-friction member 144 to further prevent friction. Here, a shape of the anti-friction member 144 is similar to the shape of each of the protrusions 142a and 142b, and the anti-friction member 144 may be made of various materials, such as urethane, or rubber, capable of reducing friction.

The opening/closing members 140a and 140b are provided in the opening portion 40 formed in the lower portion of the center rail 30 in the state in which the locking slider 100 is mounted on the center roller 20. The opening/closing members 140a and 140b are positioned in parallel with the locking slider 100.

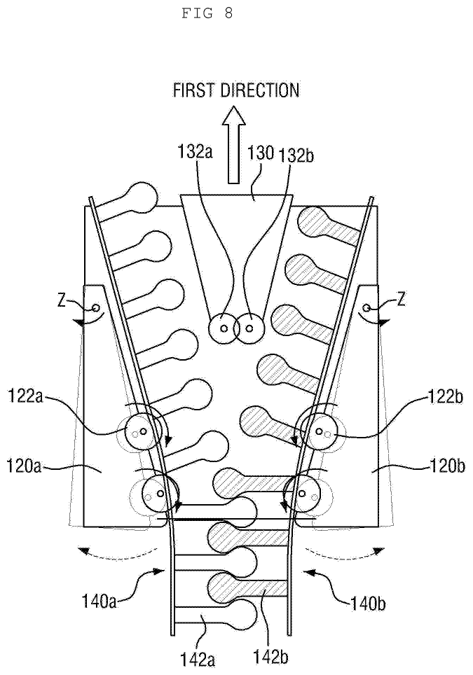

Hereinafter, an operating process of the locking slider 100 for a door trim according to the exemplary embodiment of the present invention will be described with reference to FIGS. 8 to 10.

As described above, the sliding door 10 is fixed to the vehicle body and moved by means of the center roller 20 fixed to the vehicle body, and the locking slider 100 is positioned on the movement route of the sliding door 10. In addition, since the opening/closing members 140a and 140b are provided in the opening portion 40 formed in the sliding door 10, the opening/closing members 140a and 140b move together with the sliding door 10. The predetermined regions of the opening/closing members 140a and 140b are seated on the locking slider 100. The sliding door 10 moves in the first direction or the second direction based on the locking slider 100, and the opening/closing members 140a and 140b are fastened or unfastened in accordance with the movement direction.

First, a process of fastening the two opening/closing members 140a and 140b will be described with reference to FIG. 8.

When the sliding door 10 moves in the first direction, the opening/closing members 140a and 140b seated on the locking slider 100 move together with the sliding door 10 while receiving force of the coupling members 120a and 120b. Specifically, the protrusions 142a of the left opening/closing member 140a and the protrusions 142b of the right opening/closing member 140b, which are illustrated in FIG. 8, become close to one another while moving along the inclined surfaces of the coupling members 120a and 120b. The reason is that the inclined surfaces of the coupling members 120a and 120b are inclined in the second direction and thus apply force to the left and right opening/closing members 140a and 140b from outside to inside.

The protrusions 142a and 142b of the left and right opening/closing members 140a and 140b, which become close to one another while moving along the inclined surfaces, are bent by receiving rotational force of the coupling rollers 122a and 122b formed on the inclined surface. Then, the protrusions 142a of the left (or right) opening/closing member 140a are inserted between the protrusions 142b of the right (or left) opening/closing member 140b. Specifically, as illustrated in FIG. 8, the protrusions 142a of the left opening/closing member 140a are rotated clockwise by the rotational force of the left coupling roller 122a, and the protrusions 142b of the right opening/closing member 140b are rotated counterclockwise by the rotational force of the right coupling roller 122b. That is, the rotational force allows the left and right protrusions 142a and 142b to become close and be fastened to one another.

According to the exemplary embodiment of the present invention, the other end of the coupling member 120a and the other end of the coupling member 120b in the second direction rotate during the process in which the left and right protrusions 142a and 142b are fastened to one another. Therefore, friction generated when the left and right protrusions 142a and 142b are fastened to one another may be reduced, and the fastening process is smoothly performed.

Meanwhile, since one end of each of the protrusions 142a and 142b has a circular shape, friction and noise, which are generated when the left and right protrusions 142a and 142b are inserted into one another, are minimized. In addition, friction and noise may be further minimized in the case in which the anti-friction member is provided according to another exemplary embodiment of the present invention.

When the sliding door 10 still moves in the first direction, both of the two opening/closing members 140a and 140b are fastened. Therefore, the first direction may be defined as a direction in which the sliding door 10 is closed.

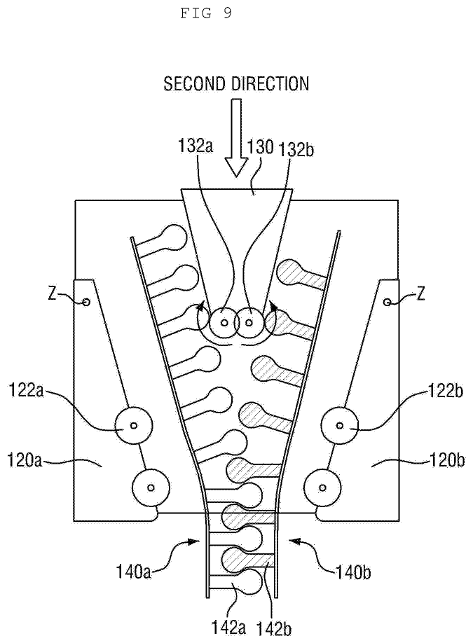

Next, a process of unfastening the two opening/closing members 140a and 140b will be described with reference to FIG. 9.

When the sliding door 10 moves in the second direction, the opening/closing members 140a and 140b seated on the locking slider 100 move together with the sliding door 10 while receiving force of the separating member 130. As illustrated in FIG. 9, the protrusions 142a of the left opening/closing member 140a and the protrusions 142b of the right opening/closing member 140b, which are fastened to one another, may be separated from one another toward both sides while receiving force from inside to outside by the one end surface of the separating member 130.

The protrusions 142a and 142b of the left and right opening/closing members 140a and 140b, which are fastened to one another, are completely separated while being bent by receiving rotational force of the separating rollers 132a and 132b formed on the one end surface of the separating member 130. Specifically, as illustrated in FIG. 9, the protrusions 142a of the left opening/closing member 140a are rotated clockwise by the rotational force of the left separating roller 132a, and the protrusions 142b of the right opening/closing member 140b are rotated counterclockwise by the rotational force of the right separating roller 132b. That is, the rotational force allows the left and right protrusions 142a and 142b to move away and be separated from one another.

The separated left and right opening/closing members 140a and 140b are widened while being spread along the inclined surfaces of the coupling members 120a and 120b.

When the sliding door 10 still moves in the second direction, both of the two opening/closing members 140a and 140b are unfastened. Therefore, the second direction may be defined as a direction in which the sliding door 10 is opened.

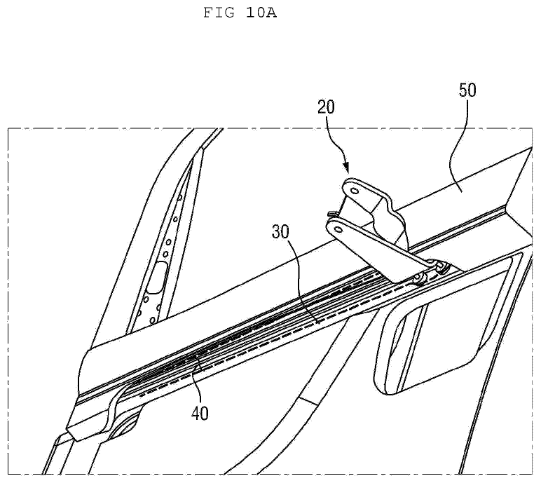

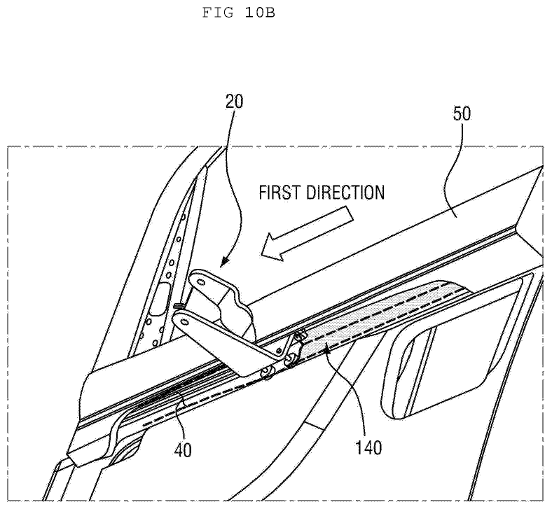

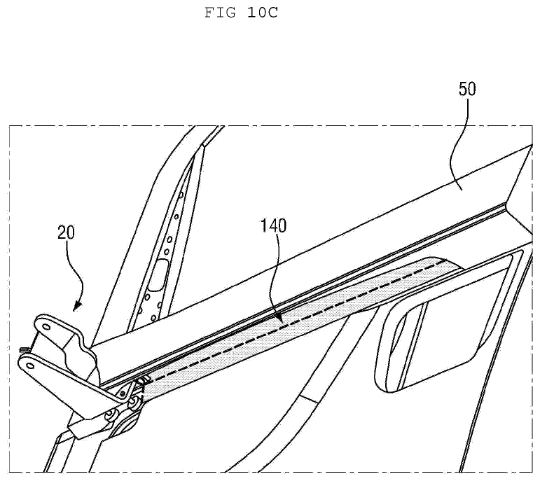

Referring to FIG. 10, FIG.10A illustrates a state in which the sliding door 10 is opened. Here, the two opening/closing members 140a and 140b are not fastened to each other in the opening portion 40 of the door trim. The reason is that there is no concern that the opening portion 40 is exposed to an occupant in the vehicle in the state in which the sliding door 10 is opened. Thereafter, as illustrated in FIG. 10B, the two opening/closing members 140a and 140b are fastened to each other while the sliding door 10 is closed. Thereafter, when the sliding door 10 is completely closed, the two opening/closing members 140a and 140b are fastened to each other to completely close the opening portion 40 of the door trim, as illustrated in FIG. 10C.

The present invention has been described with reference to the limited exemplary embodiments and the drawings, but the present invention is not limited thereto. The described exemplary embodiments may be variously changed or modified by those skilled in the art to which the present invention pertains within the technical spirit of the present invention and within the scope equivalent to the appended claims.

What is claimed is:

1. A locking slider for a door trim, which has a plate and is mounted on a center roller of a sliding door, the locking slider comprising:
two opening/closing members that are positioned on the plate to face each other and fastened or unfastened as multiple protrusions thereof engage or disengage;
two coupling members formed at both sides of the plate to face each other so as to allow the opening/closing members to be seated on a movement route of the sliding door, the coupling members configured to apply force to the opening/closing members from outside to inside; and
a separating member formed at one side of the plate so as to be positioned between the coupling members, the separating member configured to apply force to the opening/closing members from inside to outside.

2. The locking slider of claim 1, wherein a shape of one end of each protrusion has a predetermined curvature and one end of a protrusion of one opening/closing member is inserted between neighboring protrusions of the other opening/closing member, which faces the one opening/closing member.

3. The locking slider of claim 2, wherein an anti-friction member having a predetermined curvature is provided at the one end of each protrusion.

4. The locking slider of claim 1, wherein the coupling members are formed at both sides in a longitudinal direction of the opening/closing members and have predetermined inclinations so that the coupling members become close to each other in a direction from a position close to the separating member to a position distant from the separating member.

5. The locking slider of claim 4, further comprising coupling rollers provided on inclined surfaces of the two coupling members that face each other, wherein the coupling rollers are configured to rotate the protrusions of the opening/closing members so that the protrusions of one opening/closing member come into contact with the protrusions of the other opening/closing member that faces the one opening/closing member.

6. The locking slider of claim 5, wherein one end of one of the coupling members is rotatably connected to the plate and rotates in a direction away from one of the opening/closing members when the sliding door moves.

7. The locking slider of claim 1, wherein the separating member is formed in a longitudinal direction of the opening/closing members so that the separating member is positioned at a center position of the coupling members, and wherein the separating member has predetermined inclinations in a direction away from a center of the opening/closing members.

8. The locking slider of claim 7, further comprising separating rollers provided at one end of the separating member, wherein the separating rollers rotate the protrusions of the opening/closing members so that the protrusions of one opening/closing member are separated from the protrusions of the other opening/closing member that faces the one opening/closing member.

9. The locking slider of claim 8, wherein the separating rollers include a first separating roller that rotates the protrusions of the one opening/closing member in one direction, and a second separating roller that rotates, in an opposite direction, the protrusions of the other opening/closing member that faces the one opening/closing member.

10. A vehicle comprising:
a vehicle body;
a sliding door connected to the vehicle body and having a center roller;
a door trim mounted on the center roller of the sliding door, the door trim having a plate;
two opening/closing members positioned on the plate to face each other, the two opening/closing members being fastened or unfastened as multiple protrusions thereof engage or disengage;
two coupling members formed at sides of the plate to face each other so as to allow the opening/closing members to be seated on a movement route of the sliding door, the coupling members configured to apply force to the opening/closing members from outside to inside; and
a separating member formed at one side of the plate so as to be positioned between the coupling members, the separating member configured to apply force to the opening/closing members from inside to outside.

11. The vehicle of claim 10, wherein a shape of one end of each protrusion has a predetermined curvature and one end of a protrusion of one opening/closing member is inserted between neighboring protrusions of the other opening/closing member, which faces the one opening/closing member.

12. The vehicle of claim 11, wherein an anti-friction member having a predetermined curvature is provided at the one end of each protrusion.

13. The vehicle of claim 10, wherein the coupling members are formed at the sides in a longitudinal direction of the opening/closing members and have predetermined inclinations so that the coupling members become close to each other in a direction from a position close to the separating member to a position distant from the separating member.

14. The vehicle of claim 13, further comprising coupling rollers provided on inclined surfaces of the two coupling members that face each other, wherein the coupling rollers are configured to rotate the protrusions of the opening/closing members so that the protrusions of one opening/closing member come into contact with the protrusions of the other opening/closing member that faces the one opening/closing member.

15. The vehicle of claim 14, wherein one end of one of the coupling members is rotatably connected to the plate and rotates in a direction away from one of the opening/closing members when the sliding door moves.

16. The vehicle of claim 10, wherein the separating member is formed in a longitudinal direction of the opening/closing members so that the separating member is positioned at a center position of the coupling members, and wherein the separating member has predetermined inclinations in a direction away from a center of the opening/closing members.

17. The vehicle of claim 16, further comprising separating rollers provided at one end of the separating member, wherein the separating rollers rotate the protrusions of the opening/closing members so that the protrusions of one opening/closing member are separated from the protrusions of the other opening/closing member that faces the one opening/closing member.

18. The vehicle of claim 17, wherein the separating rollers include a first separating roller that rotates the protrusions of the one opening/closing member in one direction, and a second separating roller that rotates, in an opposite direction, the protrusions of the other opening/closing member that faces the one opening/closing member.
